(19) United States
(12) Patent Application Publication
(10) Pub. No.: US 2007/0296224 A1
(43) Pub. Date: Dec. 27, 2007

(54) Motorized oven lock with hidden latch

(76) Inventor: Harry Ivan Courter, Indianapolis, IN (US)

Correspondence Address: David M. Lockman;Maginot, Moore & Beck LLP, Chase Tower, 111 Monument Circle, Suite 3250, Indianapolis, IN, 46204-5109, US

(21) Appl. No.: 11/453,168

(22) Filed: Jun. 14, 2006

(51) Int. Cl. E05C 19/12

(52) U.S. Cl. 292/109

(57) ABSTRACT

An oven door lock rotates the latch arm so the latch arm is not exposed outside the oven frame when the lock is in the unlocked position. The oven door lock includes a mounting plate having a stop and a latch opening, a balance arm coupled to the mounting plate for pivoting and sliding motion, one end of the balance arm engaging the stop on the mounting plate at one end of its pivoting and sliding motion, a latch arm coupled to the balance arm for pivoting motion with respect to the balance arm, an actuator mounted to the mounting plate, a cam having a mounting hub at its center and an offset hub displaced from the mounting hub, the mounting hub of the cam being coupled to the actuator so the actuator rotates the cam with respect to the mounting plate, a directional link coupled to the offset hub of the cam and to the latch arm, the directional link pivoting and sliding the balance arm towards and away from the stop on the mounting plate during a complete revolution of the cam to move the balance arm and latch arm during the pivoting and sliding motion of the balance arm and to rotate the latch arm past an edge of the latch opening of the mounting plate as the balance arm engages the stop on the mounting plate.

### CROSS-REFERENCES

Cross-reference is made to co-pending U.S. patent application Ser. No. 10/730,296 (Attorney Docket No. 1007-0584), filed Dec. 8, 2003 entitled Motorized Oven Lock for Sealing Oven Door by Steve W. Smock, Harry I. Courter, Greg Wright and Tracy J. Talley, and U.S. patent application Ser. No. 10/730,475 (Attorney Docket No. 1007-0580), filed Dec. 8, 2003, entitled Motorized Oven Lock by Steve W. Smock, Harry I. Courter, Greg Wright and Tracy J. Talley. U.S. patent application Ser. Nos. 10/730,296 and 10/730,475 are both assigned to the same assignee as the present application and the disclosures of both applications are hereby incorporated by reference in their entirety.

### TECHNICAL FIELD

The devices disclosed herein relate generally to door locks for self-cleaning ovens and more particularly to oven door locks that block a door latch in its latched position during a self-cleaning cycle.

### BACKGROUND

A conventional gas or electric oven is subject to collecting deposits from whatever is placed in the oven to be cooked. Modern ovens are designed to self-clean upon demand by reducing these deposits to dust with high heat. This cleaning method is commonly known as pyrolytic cleaning. The high temperature used for pyrolytic cleaning poses a hazard if the oven door is opened during the cleaning cycle. To prevent this, an oven door lock is employed.

Many types of oven door locks have been provided that lock the oven door for a period sufficient to complete a pyrolytic cleaning cycle once initiated. Many of these door locks use electrical motors, electromechanical devices or manual manipulation of mechanisms to move a latch to a position in which the latch prevents the oven door from being opened during a self-cleaning cycle. Examples of such locks are disclosed in Phillips, U.S. Pat. No. 6,079,756; Thuleen et al., U.S. Pat. No. 4,082,078; McWilliams, III, U.S. Pat. No. 5,493,099; Smith, U.S. Pat. No. 6,302,098; Swartzell, U.S. Pat. No. 6,315,336; and Malone et al., U.S. Pat. No. 5,220,153.

The oven lock mechanisms in these and other known locks move a latch member between a latched and an unlatched position. In the unlatched position, the latch does not engage an edge of an opening in the oven door so the door may be opened and closed for cooking without having to operate the door lock. The latch, however, does extend beyond the front face of the oven chamber frame. The extension of the latch beyond the oven frame interferes with a clean aesthetic look of the oven chamber frame when the oven door is in the open position. Additionally, the latch requires extra attention when the oven chamber frame is cleaned and may present some risk of catching a cooking sheet or pot as it is being removed from the oven chamber. Also, the latch exposure provides an opportunity for the latch to be bent or otherwise moved out of alignment for optimal operation of the lock.

### SUMMARY

An oven lock mechanism has been developed that pulls the latch of an oven door lock within the frame so it is hidden from view because the latch does not extend beyond the front of the oven chamber frame in the unlatched position. The oven door lock mechanism includes a mounting plate having a stop and a latch opening, a balance arm coupled to the mounting plate for pivoting motion, one end of the balance arm engaging the stop on the mounting plate at one end of its pivoting motion, a latch arm coupled to the balance arm for pivoting motion with respect to the balance arm, an actuator mounted to the mounting plate, a cam having a mounting hub at its center and an offset hub displaced from the mounting hub, the mounting hub of the cam being coupled to the actuator so the actuator rotates the cam with respect to the mounting plate, a directional link coupled to the offset hub of the cam and to the latch arm, the directional link pivoting the balance arm towards and away from the stop on the mounting plate during a complete revolution of the cam to move the balance arm and latch arm during the pivoting motion of the balance arm and to rotate the latch arm past an edge of the latch opening of the mounting plate as the balance arm engages the stop on the mounting plate.

Additional features and advantages of the disclosed oven lock are apparent to those skilled in the art upon consideration of the following detailed description of preferred embodiments exemplifying the best mode of implementing a motorized oven lock as presently perceived.

### BRIEF DESCRIPTION OF THE DRAWINGS

The illustrative devices will be described hereinafter with reference to the attached drawings which are given as non-limiting examples only, in which:

FIG. 1 is a perspective view of a self-cleaning oven with the oven door closed and the oven lock mechanism, which is shown in phantom lines, mounted at the front of the oven frame above the cooking chamber and below the cook top.

FIG. 2 is a top perspective view of the oven lock mechanism shown in locked position of FIG. 1.

FIG. 3 is a top perspective view of the oven lock mechanism depicting the withdrawing of the latch arm to its hidden unlocked position.

FIG. 4 is a top perspective view of the oven lock mechanism depicting movement of the latch arm towards the locked position.

FIG. 5 is a top plan view of the oven lock mechanism with the latch arm in the fully extended position prior to pulling in the oven door to its locked position.

FIG. 6 is a top plan view of the oven lock mechanism with the latch in its locked position with the latch arm holding the oven door in its pulled in, locked position.

### DETAILED DESCRIPTION

The oven door lock mechanism 30 illustrated and described herein enables the latch mechanism 30 to move a latch 36 to a position that locks the oven door 12 in response to a user selecting the self-cleaning cycle for the oven. Such a position is referred to herein as a latched position. The disclosed mechanism 30 facilitates movement of the latch 36 between the latched and unlatched positions without requiring springs or guide slots.

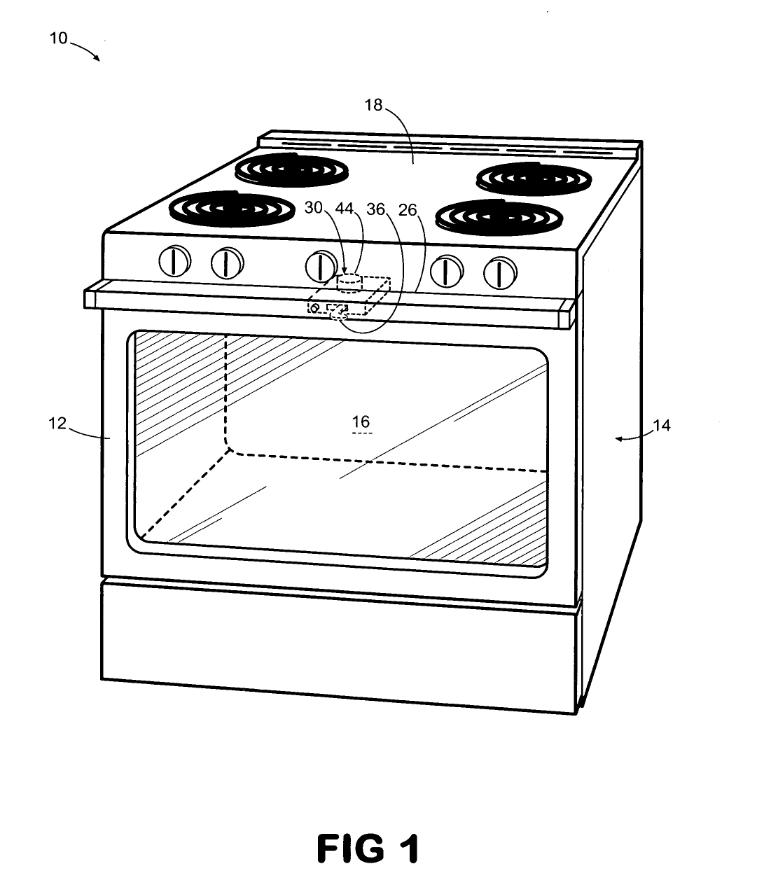

As shown in FIG. 1, for example, the illustrated embodiment of the oven lock mechanism 30 is configured for mounting in a self cleaning oven 10. The oven 10 includes a door 12 hinged at its bottom to a frame 14. The frame 14 of the oven 10 is disposed about an oven chamber 16. A cook top 18 is coupled to the frame and disposed above the oven chamber 16. The door 12 closes at an interface formed by an inner face of the door 12 and an abutment surface of the oven frame 14. The inner face of oven door 12 may be provided with a seal for engaging the abutment surface of the frame 14 to help seal oven chamber 16. Those skilled in the art will recognize that alternatively, the abutment surface of the frame 14 may be provided with a seal for engaging the inner face of the oven door 12. The disclosed embodiment of the oven door lock mechanism 30 is mounted at the top 26 of the frame 14 of the oven 10 just under the cook top 18.

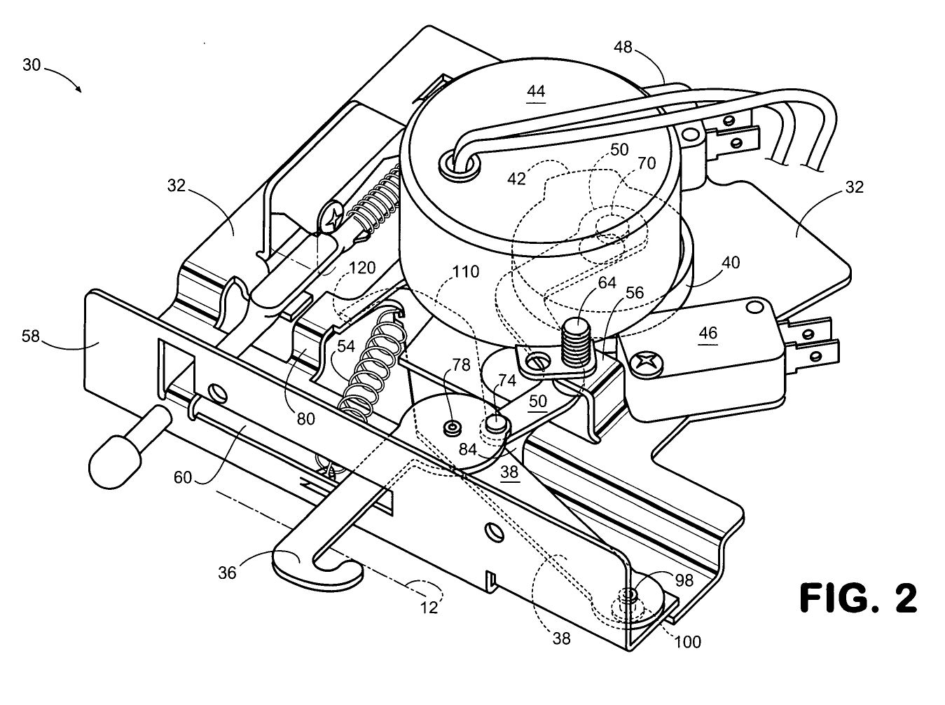

As shown in FIG. 2, for example, the illustrated oven lock mechanism 30 includes a mounting plate 32, a latch arm 36, a balance arm 38, a cam 40, a motor 44, two cam-actuated snap switches 46 and 48, a directional link 50, and a biasing member 54. In more detail, the mounting plate 32 may be a stamped or extruded metal piece made of, for example, G30 galvanized steel. The plate 32 provides a mounting surface for the components of the oven lock mechanism 30. An upturned flange 58 is formed with a latch opening 60 through which the latch 36 extends for its latching function and behind which it is stored when it is unlatched. The latch arm 36, the balance arm 38, the cam 40, the motor 44, switches 46 and 48, the directional link 50 and the biasing member 54 are mounted on one side of mounting plate 32 in the embodiment shown in FIG. 2, although the motor 44 may be mounted on the other side of the plate. The latch arm 36 or other moving components, such as the balance arm 38, may also be made from nickel-plated steel to improve the durability of the part to wear from any engagement that may occur during the movement of the latch components. Snap action switches 46 and 48 may be mounted to plate 32 using known methods, such as screws, for example.

Screws 64, for example, may also be used to mount the motor 44 to the mounting extrusions 56 that extend upwardly from the plate 32, as shown in FIG. 2. An output shaft of the motor 44 is eccentrically located with respect to the center of the motor and extends downwardly towards the plate 32. The motor may be, for example, a synchronous induction AC high torque Oven Door Lock class “F” motor. Motor 44 may operate at 3 RPM in response to a 120 VAC, 60 Hz signal, although other speeds and operating voltages may be used.

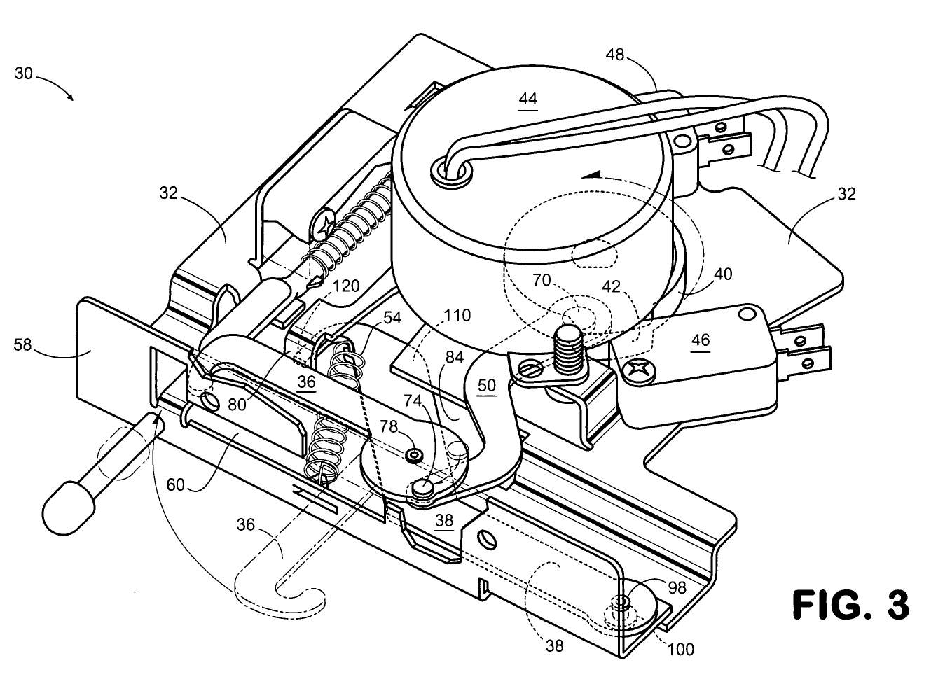

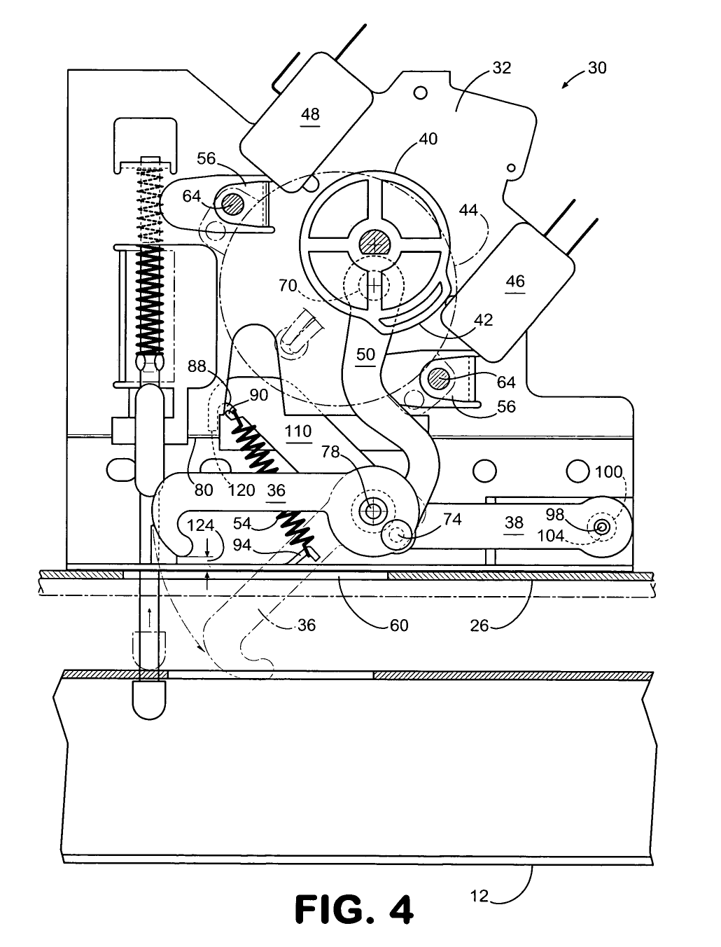

With reference to FIG. 3, the directional link 50 is a curved arm that is coupled between an offset hub 70 of the cam 40 and a pivot pin 74 that extends through the latch arm 36. Preferably, the directional link 50 is coupled to the latch arm 36 at a position that is off-center with respect to the mounting end of the latch arm for directing the movement of the latch arm 36 and the balance arm 38. The eccentric coupling of the directional link 50 enables the motor 44 and the cam 40 to rotate the latch arm about the center pivot 78 that couples the latch arm 36 to the balance arm 38 and to translate the center pivot 78 towards and away from the motor 44. Of course, the latch arm 36 and the balance arm 38 follow the center pivot 78 as it is moved. Although the directional link 50 is shown as a curved arm, it may be other various shapes, such as a straight cylindrical rod with turned down ends for coupling to the offset hub 70 and the latch arm 36. As may be seen in FIG. 3 and FIG. 4, the mounting plate 32 is stamped to provide a stop 80 and a balance arm opening 84. The balance arm 38 is formed with a cutout 88 and a tang 90 to which one end of biasing member 54 is coupled. The other end of the biasing member 54 is coupled to a tang 94 extending from the flange 58 of the mounting plate 32. The biasing member 54 may be a coiled spring or other member having tensile memory for urging the end of the balance arm 38 coupled to the biasing member towards the stop 80.

The other end of the balance arm 38 is mounted about a pivot pin 98. The pivot pin 98 has an enlarged head 100 that traps a portion of the mounting plate between it and the balance arm 38. Preferably, the pivot pin opening 104 is a circular hole that accommodates passage of the pivot pin through the mounting plate 32. Even when the latch arm 36 is in position to hold the oven door in the locked position, the balance arm 38 is able to pivot a distance about its pivot pin 98. By inserting a tool in a known manner between the door and the oven frame and urging the tool against the latch arm with sufficient force, the balance arm 38 pivots enough to disengage the latch arm 36 from the oven door. This feature enables an oven, in which the locking mechanism has become inoperative while in the locked position, to be opened. Although the balance arm can be forced to pivot sufficiently to free the oven door, the opening 104 may also include an escape slot to increase the range of movement for the balance arm 38 and the latch arm 36. Such a slot may also include a blocking member or frangible extension formed from the mounting plate, for example, to impede movement into the escape slot until such movement is required to release the oven door from an inoperative lock.

The balance arm 38 is shown as having two ends with straight sections that are joined with an offset leg 110. Other configurations of the balance arm may be used, however. The balance arm 38, as noted above, is coupled to the latch arm 36 with the center pivot pin 78. The balance arm 38 enables the latch arm 36 to rotate freely about the center pivot 78 until the latch arm 36 encounters an edge of the opening 60. At that point, the force applied by the directional link 50 to the latch arm 36 is no longer able to rotate the latch arm 36, and is, instead, transferred to the balance arm through the center pivot pin 78. During the remainder of the cam rotation, as discussed in more detail below, the balance arm pivots about its pivot pin 98 as the directional link 50 continues to exert force on the latch arm 36. As the balance arm 38 pivots, it carries the center pivot 78 and the latch arm 36 away from the flange 58. Thus, the balance arm translates the latch arm rearward with respect to the latch opening during the locking operation of the lock. The self-cleaning cycle may then be performed after the oven door is in the locked position.

Once the cleaning operation is performed, the cam is driven to continue its rotation and the locking movement is reversed. Specifically, the movement of the directional link 50 caused by the cam rotation results in the balance arm moving forward. The forward translation of the balance arm continues until the biased end of the balance arm is directed to the stop 80. At this point, the base end of the latch arm 36 is near the flange 58, but short of the opening 60. As the stop 80 block further pivoting of the balance arm 38, the latch arm 36 is released so it is able to rotate freely. Continued rotation of the cam causes the directional link to rotate the hook end of the latch arm 36 through the opening 60 and past the flange 58 so that the hook end of the latch arm 36 is hidden within the oven frame. Consequently, the latch arm 36 is not exposed outside of the oven frame when the locking mechanism is in the unlocked position. This retraction presents a better aesthetic appearance, facilitates cleaning of the oven chamber frame, and reduces the risk that the latch arm catches a vessel or sheet being placed within or removed from the oven chamber.

The cam 40, as shown in FIG. 3 and FIG. 4, is primarily circular in shape with a mounting collar located at its center. The mounting collar typically has a D-shaped opening to mount the D-shaped output shaft of typical Oven Door Lock motors, although other shapes may be used for the motor output shaft and cam mounting collar. The cam is preferably formed from a plastic material, such as glass-filled nylon, although other materials may be used. On the side opposite the motor 44, an offset hub 70 is provided on the cam 40. The offset hub is eccentrically located on the cam 40 to rotationally displace the directional link 50 as the cam is rotated by the motor 44.

The top view of the mechanism 30, shown in FIG. 4, demonstrates the full retraction of the latch arm 36 behind the flange 58. In this position, the latch arm 36 is not exposed in the latch opening 60 in the flange 58. End 120 of the balance arm 38 is urged by biasing member 54 against stop 80. The latch arm 36 has been sufficiently rotated and translated that a gap 124 is established between the hook end of the latch arm 36 and the flange 58. This gap may be sized to account for manufacturing tolerances in components as well as wear of components during the operational life of the lock to help ensure that the hook end of the latch arm 36 remains behind the flange 58 when the lock is in the unlatched state. The gap between the door 12 and the flange 58 may be filled by the oven door seal (not shown) as discussed above. The biasing member 54 is shown as being in its most relaxed state, but still being taut enough to pull the end 120 of the balance arm 38 against stop 80 of the mounting plate 32. The latch arm 36, in this position, is free to rotate.

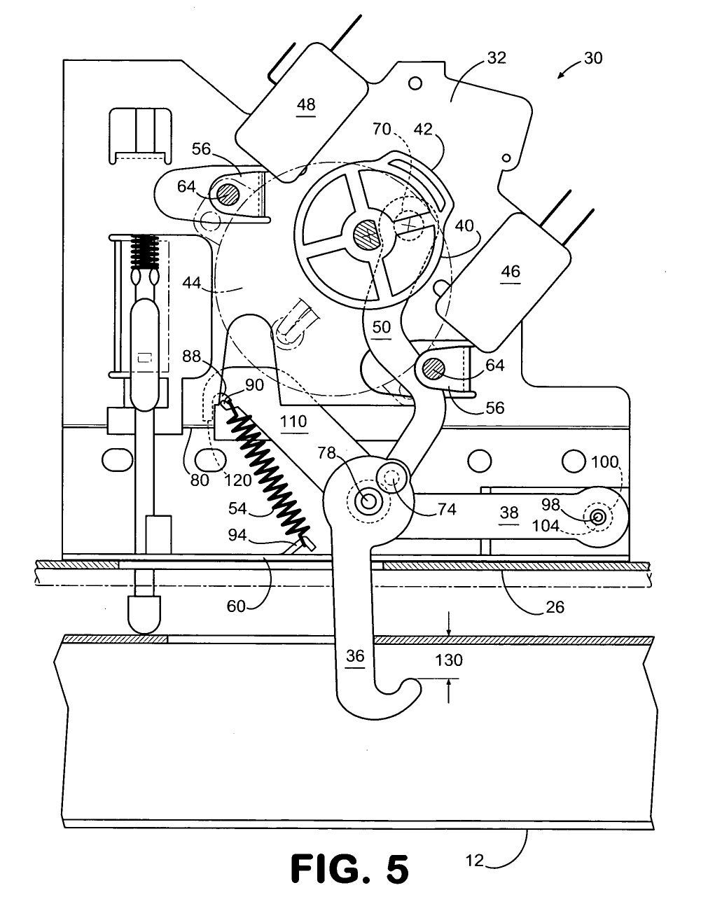

In FIG. 5, the latch arm 36 is shown approximately halfway to the locked position. As described in more detail below, the cam 40 has rotated approximately ninety degrees to the position shown in FIG. 5. This rotational movement is delivered by the directional link 50 to the latch arm 36 so it freely rotates from the unlatched position to the position shown in FIG. 5. At this position, a gap 130 exists between the hook of the latch arm 36 and the back side of the door face 12. This gap helps ensure that the hook does not impinge on the door 12 during its rotational movement. The latch arm 36 is no longer able to rotate as it its rotation is blocked by an edge of the opening 60. Consequently, continued rotation of the cam 40 results in force delivered by the directional link 50 to be coupled to the balance arm 38, which translates towards the motor 44 to pull the latch arm 36 towards the rear of the oven. During this rearward movement, the hook meets the back side of the door face 12 and continues to pull in the door, compressing the door gasket, until the motor is turned off and door is held in its pulled-in, locked position by the latch arm 36.

As shown in FIG. 5, the mounting plate 32 has snap action switches 46 and 48 mounted to the plate at positions proximate to the cam 40. The cam 40 includes an eccentric lobe 42 that selectively interacts with the actuators of the snap action switches 46 and 48 as the cam 40 rotates. The lobe 42 engages a spring-biased switch actuator extending from a switch and urges the actuator against its spring bias as the cam lobe passes by the actuator. In this manner, the actuator is depressed into a switch to change the state of the switch contacts. As the lobe passes the actuator, the actuator is released so it fully extends and the state of the contacts reverts to the state that existed prior to engagement by the cam lobe. The snap switches 46 and 48 are either normally open or normally closed switches with the actuator in the extended position. The changes in the state of the switches as the cam lobe rotates may be monitored by a controller for the oven to determine when to couple and de-couple motor 44 to power.

In more detail, the lock mechanism 30 is installed in an oven so the mechanism is below the countertop and above the oven chamber. The lock mechanism is centered so the latch 36 extends through the opening 60 and can selectively engage with and disengage from the oven door. With the latch in the hidden position, shown in FIG. 4, the oven door opens and closes for normal use. In this position, the lobe 42 of the cam 40 is engaging the actuator of one of the snap switches so that the actuator is depressed.

In response to the self-cleaning cycle being selected, an electrical circuit for powering the motor is closed so the motor 44 begins to rotate. Alternatively, selection of the self-cleaning cycle may change the state of a switch that is coupled to an oven controller so the controller closes a circuit and powers the motor. As the cam 40 rotates, the lobe 42 moves to a position that allows the actuator to fully extend so the switch 46 changes state. This change in state indicates the cam is rotating. As the cam continues to rotate, it moves the directional link 50 so the latch arm 36 rotates about the center pivot 78 and swings to a position that is effectively perpendicular to the oven door with the gap 130 between the hook of the latch arm 36 and the back side of the oven door, as shown in FIG. 5.

As the cam 40 continues to rotate, the directional link 50 pulls the latch arm 36 rearward. This translation of the latch arm 36 also pivots the balance arm 38 about its pivot pin 98. The pivoting of the balance arm 38 moves the end 120 of the balance arm 38 away from the stop 80 against the urging of the biasing member 54. This motion continues until the lobe 42 of the cam 40 engages and depresses the actuator of the next snap switch 48. Upon depression of the actuator, the state of the switch 48 changes to indicate the travel of the cam 40. In response to this state change, the electrical circuit powering the motor 44 is opened and the motor is decoupled from power so the cam 40 stops rotation and the oven remains locked. Alternatively, the state change in the switch 48 may be detected by an oven controller that decouples the motor 44 from electrical power.

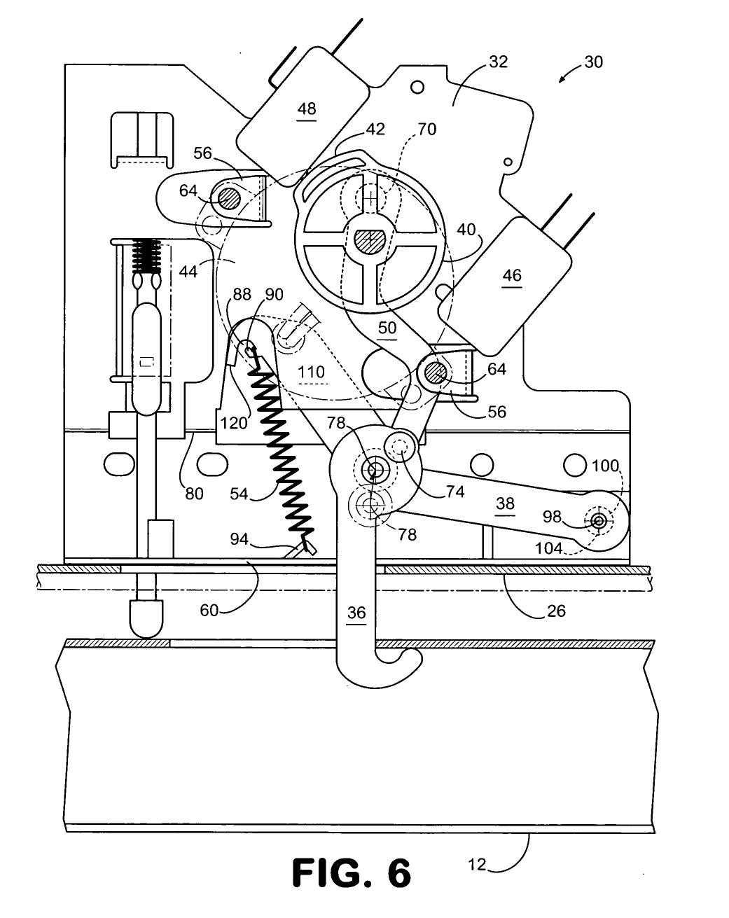

If the locking mechanism becomes inoperative in this position, the latch arm 36 may be moved to release the oven door by inserting a known tool between the oven door and the flange 58. By urging the tool to the left while the latch arm 36 is in the position shown in FIG. 6, the force on the latch arm 36 is transferred through the center pivot 78 to the balance arm 38. This force causes the balance arm 38 to rotate about its pivot pin 98 and carry the latch arm 36 to a position that releases the hook of the latch arm 36 from the oven door. The oven door may then be moved to an open position.

Upon completion of the self-cleaning cycle with the locking mechanism operational, the electrical circuit for powering the motor is closed so the motor 44 begins to rotate in the same direction again. Alternatively, deactivation of the self-cleaning cycle may change the state of a switch (not shown) that is coupled to an oven controller so the controller closes the circuit and powers the motor so it begins rotating in the counter-clockwise direction, as shown in the FIG. 6. As the cam 40 rotates, the lobe 42 releases the actuator of the snap switch 48 to indicate the cam has begun rotation. The directional link 50 delivers this movement to the latch arm 36 where it is transferred to the balance arm 38. In response, the balance arm 38 pivots about its pivot pin 98 and end 120 of the balance arm 38 also begins to move towards the stop 80 under the urging of the biasing member 54. After approximately ninety degrees of rotation, the end 120 encounters the stop 80 and the pivoting motion of the balance arm ends. As a result, the latch arm 36 is free to rotate and the force delivered by the directional link 50 causes the latch arm 36 to rotate about the center pivot 78. The next approximately ninety degrees of cam rotation cause the latch arm 36 to move past the flange 58. After the cam has completed its 180 degree rotation, the lobe 42 engages and depresses the actuator of the next snap switch 46 and the motor 44 is decoupled from power so the cam rotation stops. Once again, the user of the oven is able to open and close the door freely and the latch arm 36 remains within the boundaries of the locking mechanism so it is hidden within the oven door frame.

Although the oven door lock has been described in detail with reference to a certain illustrative embodiments, variations and modifications exist within the scope and spirit of the oven door lock as described and defined in the following claims. For example, while the operation of the lock has been described with reference to a motor and a cam that rotate in one direction, the motor and the cam driven by the motor could be bi-directional. Other variations and configurations are available.

1. An oven door lock mechanism comprising:
a mounting plate having a stop and a latch opening; a balance arm coupled to the mounting plate for pivoting motion, one portion of the balance arm engaging the stop on the mounting plate at one end of the pivoting motion of the balancing arm;
a latch arm coupled with a pivot pin to the balance arm to enable the latch arm to pivot about the pivot pin; and
an actuator mounted to the mounting plate, the actuator being coupled to the latch arm and the balance arm to move the balance arm and latch arm during the pivoting motion of the balance arm and to rotate the latch arm past an edge of the latch opening of the mounting plate as the balance arm engages the stop on the mounting plate.

2. The locking mechanism of claim 1 further comprising:
a cam having a mounting hub at a center of the cam and an offset hub displaced from the mounting hub, the mounting hub of the cam being coupled to the actuator so the actuator rotates the cam with respect to the mounting plate; and
a directional link, one portion of the directional link being coupled to the offset hub of the cam and another portion of the directional link being coupled to the latch arm to pivot the balance arm towards and away from the stop on the mounting plate and to rotate the latch arm while the balance arm engages the stop on the mounting plate.

3. The mechanism of claim 2, the directional link being coupled to the latch at a position to enable a cam rotation of approximately 180 degrees in one rotational direction to move the latch arm out of engagement with an oven door and to rotate the latch arm past the edge of the latch opening so the latch arm is not exposed at the latch opening and to enable a cam rotation of approximately an additional 180 degrees in the same rotational direction to rotate the latch arm past the edge of the latch opening so the latch arm is substantially perpendicular to the oven door and to move the latch arm into engagement with the oven door to lock the oven door into a closed position.

4. The mechanism of claim 3, the directional link being coupled to the latch arm at a position offset from the pivot pin coupling the latch arm to the balance arm.

5. The mechanism of claim 4, the balance arm further comprising:
an offset leg that joins the end of the balance arm mounted to the mounting plate to the portion of the balance arm that engages the stop on the mounting plate.

6. The mechanism of claim 5, wherein the latch arm is coupled by the pivot pin to the offset leg of the balance arm.

7. The mechanism of claim 6, the cam further comprising:
an eccentric lobe; and
a pair of snap switches mounted proximate the cam so that the eccentric lobe engages a switch actuator of at least one of the snap switches during one of the rotations of approximately 180 degrees.

8. The mechanism of claim 2 wherein the directional link is a curved arm.

9. An oven door lock mechanism for use with an oven having a door and a frame configured so that the door is adjacent the frame when the door is closed, the lock mechanism comprising:
a mounting plate having a stop and a latch opening;
a balance arm coupled to the mounting plate for pivoting motion, one portion of the balance arm engaging the stop on the mounting plate at one end of its pivoting motion;
a latch arm coupled by a pivot pin to the balance arm to enable the latch arm to pivot independently of the balance arm;
an actuator mounted to the mounting plate;
a cam having a mounting hub at a center of the cam and an offset hub displaced from the mounting hub, the mounting hub of the cam being coupled to the actuator so the actuator rotates the cam with respect to the mounting plate;
a directional link, one portion of the directional link being coupled to the offset hub of the cam and another portion of the directional link being coupled to the latch arm, the directional link pivoting the balance arm towards and away from the stop on the mounting plate during a complete revolution of the cam to move the balance arm and latch arm during the pivoting motion of the balance arm and to rotate the latch arm past an edge of the latch opening of the mounting plate as the balance arm engages the stop on the mounting plate.

10. The locking mechanism of claim 9 further comprising:
a biasing member coupled between the mounting plate and the balance arm, the biasing member urging the balance arm to engage the stop on the mounting plate.

11. The locking mechanism of claim 10 wherein the biasing member is a spring.

12. The mechanism of claim 10, the directional link being coupled to the latch arm at a position offset from the pivot pin coupling the latch arm to the balance arm.

13. The mechanism of claim 12, the balance arm further comprising:
an offset leg that joins the end of the balance arm mounted to the mounting plate to the portion of the balance arm that engages the stop on the mounting plate.

14. The mechanism of claim 13, wherein the latch arm is coupled by the pivot pin to the offset leg of the balance arm.

15. An oven door lock mechanism for use with an oven having a door and a frame configured so that the door is adjacent the frame when the door is closed, the lock mechanism comprising:
a mounting plate having a stop and a latch opening:
a balance arm having an offset leg. the balance arm being coupled at one end to the mounting plate for pivoting motion and another end of the balance arm engaging the stop on the mounting plate at one end of the pivoting motion:
a biasing member coupled between the mounting plate and the balance arm, the biasing member urging the balance arm to engage the stop on the mounting plate:
a latch arm coupled to the offset leg of the balance arm for pivoting motion with respect to the balance arm:
a center pivot that couples the balance arm and the latch arms:
an actuator mounted to the mounting plate: and
a cam having a mounting hub at its center and an offset hub displaced from the mounting hub, the mounting hub of the cam being coupled to the actuator so the actuator rotates the cam with resPect to the mounting plate: a directional link coupled to the offset hub of the cam and to the latch arm, the directional link pivoting the balance arm towards and away from the stop on the mounting plate during a complete revolution of the cam to move the balance arm and latch arm during the pivoting motion of the balance arm and to rotate the latch arm east an edge of the latch opening of the mounting plate as the balance arm engages the stop on the mounting plate.

16. The mechanism of claim 14, the directional link being coupled to the latch at a position to enable a cam rotation of approximately 180 degrees in one rotational direction to move the latch arm out of engagement with an oven door and to rotate the latch arm past the edge of the latch opening so the latch arm is not exposed at the latch opening and to enable a cam rotation of approximately an additional 180 degrees in the same rotational direction to rotate the latch arm past the edge of the latch opening so the latch arm is substantially perpendicular to the oven door and to move the latch arm into engagement with the oven door to lock the oven door into a closed position.

17. The mechanism of claim 16, the cam further comprising:
an eccentric lobe; and
a pair of snap switches mounted proximate the cam so that the eccentric lobe engages a switch actuator of at least one of the snap switches during a rotation of approximately 180 degrees.

18. The mechanism of claim 9 wherein the directional link is a curved arm.
